(19) United States
(12) Patent Application Publication
(10) Pub. No.: US 2008/0268098 A1
(43) Pub. Date: Oct. 30, 2008

(54) High-Fiber Soybean Products and Process for the Preparation Thereof

(76) Inventors: Sang Kyun Cho, Gyeonggi-do (KR); Jin Sang Park, Busan (KR); Seung Hoon Oh, Gyeonggi-do (KR)

Correspondence Address: SUGHRUE MION, PLLC, 2100 PENNSYLVANIA AVENUE, N.W., SUITE 800, WASHINGTON, DC, 20037, US

(21) Appl. No.: 12/092,841

(22) PCT Filed: Oct. 9, 2003
(86) PCT No.: PCT/KR06/04037

§ 371 Date: May 7, 2008

(30) Foreign Application Priority Data
Nov. 7, 2005 (KR) 10-2005-0106104

(51) Int. Cl. A23L 1/20

(52) U.S. Cl. 426/46; 426/598; 426/634

(57) ABSTRACT

A process for preparing a whole soybean food product including the steps of: mechanically milling soaked or germinated soybeans; micronizing the resulting crude milled soybeans by an enzymatic means, mechanical means or a combination thereof; and homogenizing the resulting soybean milk, without producing soybean refuse, provides whole soybean food products containing the entire nutritious components of soybeans, the process being environmentally friendly because no soybean peel refuge is generated.

### FIELD OF THE INVENTION

The present invention relates to a process for preparing high-fiber whole soybean milk containing entire nutritive components of soybean, and soybean foods employing same, without generating any soybean peels or curd refuse.

### BACKGROUND OF THE INVENTION

Soybean peels (or soybean hulls) are refuses generated in a large amount during the process for preparing soybean oil, milk or curd, and they contain about 40% by weight of crude fibers, having high absorbability (Klopfenstein, T. and F. Owen, April, 1987, Soybean Hulls, Animal Health & Nutrition, 28).

The soybean peels of relatively low crude protein content have been used as a high-quality feed in the field of stock breeding. Recently, the nutritious value of the soybean peels was acknowledged and many studies thereof have been carried out for fortifying fibers to foods having low fiber content, especially for confectionery such as cookies, muffins and breads (Seung-Ho Kim, Korea Food Research Institute, 1995).

Bioactive components obtainable from soybean peels and germs include crude fibers; isoflavones for preventing cancer and facilitating hormone metabolism; saponins for helping lipid metabolism and having an anti-oxidative effect; phytins which regulate the cholesterol metabolism; oligosaccharides helping the digestive function; and lecithin participating in the mechanism of defense reaction of a living body (M. Sugano et al., Journal of the Brewing Society of Japan, 99(3), 148-155). However, such beneficial components are lost during the conventional process for preparing soybean products because most of the soybean peels and germs are removed during the conventional process. Accordingly, a soybean food product prepared by a conventional process comprises only a limited part of the nutritive components of soybean.

A conventional process for preparing soybean curd includes the steps of selecting and peeling soybeans, washing, soaking in water, milling, heating, removing curd refuse by filtration, coagulating filtered soybean milk and packaging. In such conventional process, various nutritive components such as fibers and minerals contained in the soybean curd refuse, especially, fibroid materials rich in the soybean peels are discarded during the step of removing the soybean curd refuse. Further, in the process employing peeled soybean, the soybean germs having highly concentrated nutritive components are removed during the peeling of soybeans.

Hitherto, various attempts have been made to prevent the loss of nutritious components during the soybean curd preparation; e.g., by way of: preparing a whole soybean curd by employing a micronized soybean powder of dried raw soybeans (see Korean Patent Laid-open Publication Nos. 2002-92272 and 2002-92282); and preparing a whole soybean curd containing the curd refuse components by soaking the soybeans in water, and milling, micronizing and homogenizing the soaked soybeans (see Korean Patent Laid-open Publication Nos. 2005-23778 and 2005-34176).

However, the method employing the powder of raw soybeans has the problem that the soybean food product prepared thereby has a coarse texture and inferior taste because it is difficult to homogenously micronize the soybean powder. Further, the dried soybean powder and a soybean food product prepared therefrom are not suitable for long-term storage because oils or fats contained in the powder are prone to undergo oxidation during the storage.

Moreover, when pre-peeled and soaked soybeans are used in the process for preparing a soybean food product, the problem of losing some of the nutritious components may occur due to the dissolution of proteins and saccharides in the water depending on the soaking period or temperature (Y. H. Lee et al., Journal of Korean Society of Food Science and Technology, 19(6): 491-492, 1987).

Accordingly, the present inventors have endeavored to develop a process for preparing a soybean food product having a good taste, which does not require the steps of separating and discarding curd refuses and soybean peels; and have developed a novel process for preparing a soybean food product, which retains 100% of the nutritive components of whole soybean and has excellent taste and texture.

### SUMMARY OF THE INVENTION

Accordingly, it is an object of the present invention to provide a process for preparing soybean milk retaining the entire nutritious components of whole soybean including fibroid materials (hereinafter, referred to as “whole soybean milk”), without producing the soybean peels or curd refuse.

It is an object of the present invention to provide a process for preparing a soybean food product having an excellent texture and taste by employing said whole soybean milk, and a soybean food product prepared by the process.

In accordance with one object of the present invention, there is provided a process for preparing whole soybean milk, comprising the steps of mechanically milling soybeans; micronizing the resulting milled soybeans by a means selected from the group consisting of an enzymatic means, mechanical means or a combination thereof; and homogenously micronizing the resulting soybean milk.

Further, in accordance with another object of the present invention, there is provided process for preparing whole soybean milk comprising the steps of mechanically milling soaked or germinated soybeans; filtering the resulting crude milled soybeans to obtain a solid portion and soybean milk (first soybean milk), and micronizing the solid portion by a means selected from the group consisting of an enzymatic means, mechanical means or a combination thereof; and homogenizing the resulting micronized solid portion to obtain soybean milk (second soybean milk) and mixing the second soybean milk with the first soybean milk.

In accordance with a further object of the present invention, there is provided a process for preparing a whole soybean food product by employing the whole soybean milk prepared by the above process; and a whole soybean food product prepared therefrom.

### DETAILED DESCRIPTION OF THE INVENTION

As used herein, the term “soybean food product” means various kinds of foods obtained by processing soybeans, and is the general term for the foods prepared by employing the entire soybean components, e.g., soybean milk, curd, soup and snack, excluding foods prepared by employing only a portion of the soybean components such as soybean oil and soy sauce.

The term “whole soybean components” means the whole nutritious components of soybeans, including curd refuse as well as soybean peels.

The term “germinated soybeans” means the soybeans germinated under appropriate temperature and humidity conditions. Upon germination of soybeans, a part of the soybean proteins is converted into free amino acids having sweet and savory tastes, during which vitamin C is formed, the vitamin B₂ and B₁₆ contents increase by 2 and 10 folds, respectively, and its calorie value and fat content decrease.

In the present invention, germinated soybeans or soaked soybeans prepared by soaking non-peeled whole grains of soybean may be used as a starting soybean feed material.

The soaked soybeans may be prepared as follows: First, appropriate whole soybean grains are selected, washed, and soaked in 3- to 5-fold volume of water to allow water penetrate into the interior of the soybeans. The temperature of soaking water may range from 10 to 20° C., while a higher temperature may be employed in winter. However, some of the soybean components may be released or degrade when soaked at a temperature over 35° C. The soaking period may range from 5 to 20 hours, which may be regulated depending on the temperature of soaking water. The soaking period may be shortened as the temperature of soaking water becomes high. For instance, the soaking period is preferably about 10 hours in 20° C. water. The volume of soaked soybeans increase about 2 to 2.3 folds during the soaking.

The germinated soybeans are commercially available or can be obtained by the following process.

Water is removed from the soaked soybeans and the soybeans are germinated at a temperature ranging from 20 to 25° C. At this time, it is preferable to cover the soybeans with a lid or cloth to keep them moist and warm. The soybeans may be watered at an interval of 2 or 3 hours with a sufficient amount of water having a temperature ranging from 18 to 22° C. to promote budding. In order to enhance the taste of the food prepared from the germinated soybeans, it is preferable to germinate soybeans so that the length of the bud (hypocotyl) is shorter than 30 mm, more preferably, 3 to 15 mm. Such germinated soybeans can be prepared by germinating soybeans at a temperature ranging from 20 to 25° C. for 72 hours or less, preferably, for a period ranging from 36 to 60 hours.

More specifically, the inventive process for preparing a whole soybean milk comprises the steps of mechanically milling feed soybeans, e.g., by a mill such as a crusher; micronizing the resulting crude-milled soybeans by a means selected from the group consisting of an enzymatic degradation reaction, mechanical micronization using a rotating micronizer, or a combination thereof; and homogenizing the resulting micronized milled soybean. Optionally, the crude-milled soybeans may be filtered to separate the initially generated soybean milk (first soybean milk) and a solid portion containing curd refuse and soybean peels; the micronization and homogenization of the solid portion is carried out to obtain a second batch of soybean milk (second soybean milk); and the second soybean milk is combined with the first soybean milk to obtain the whole soybean milk. In the optional process, the micronized solid portion may be combined with the first soybean milk, followed by homogenizing the resulting mixture to obtain the whole soybean milk.

Further, in accordance with another inventive process, a whole soybean food product containing the entire nutritious components of soybean, having a superior quality such as an excellent texture and taste is provided. The inventive process is environmentally friendly because it generates no waste soybean peels.

The process of the present invention may be conducted by the following procedures.

1) Milling and Enzyme Inactivation

A soybean feed is milled with a mechanical pulverizing apparatus, e.g., a mill (crusher), while adding water thereto in an amount of 4.5 to 4.9 folds based on the feed weight at room temperature. At this time, it is preferable to conduct the milling until the level wherein the soluble components of soybeans are sufficiently separated from the soybean peels and curd refuse.

Then, enzymes in the feed soybean is inactivated by heating the soybeans before the milling or the soybean slurry obtained after milling at a temperature ranging from 95 to 110° C. for 2 to 5 minutes.

2) Optional Milk-Solid Separation

In order to enhance the micronization efficiency of the solid components, the soybean slurry obtained after milling is passed through a decanter to separate the first batch of soybean milk (first soybean milk) and solid materials composed mostly of curd refuse and soybean peels.

3) Micronization and Enzyme Degradation

The soybean particles in the soybean slurry prepared in step 1) or in the solid materials obtained in step 2) are micronized with a rotating micronizer. The rotating micronizer is generally equipped with a millstone-type cutter at its upper and lower parts and the cutters rotate at a high-speed to micronize the particles at regular intervals. An example of the rotating micronizer is a high-speed milling machine. During the rotating micronization, a plant tissue-degrading enzyme such as cellulase, hemicellulase, pectinase and a mixture thereof may be added alone or in combination to the slurry or solid materials, at a temperature ranging from 50 to 65° C., preferably, 60° C., to induce enzymatic degradation. The milk obtained by micronizing the solid materials obtained in step 2) (second soybean milk) is combined with the first soybean milk.

4) Micronizing Homogenization

In this step, the milk obtained in step 3) is subjected to micronizing homogenization by high-pressure homogenization, sonication, electrolysis or air pressure spray to obtain whole soybean milk. Micronizing homogenization is carried out for the purpose of promoting the micronization of particles and producing a even particle size distribution, to prevent the precipitation of particles caused by solid-liquid separation, aggregation of fat globules, and to prevent gelatinization of soybean particles.

The high-pressure homogenization is preferably selected from the above-mentioned micronizing homogenization methods, and the high-pressure homogenization may be performed by transferring the soybean milk into a high-pressure homogenizer and applying a pressure ranging from 150 to 700 bar to the milk at least one time, preferably, one to six times and, more preferably, three to five times.

At this time, the applied pressure and application times can be appropriately chosen by taking into consideration the type of the desired final product: Thorough homogenization is required for soybean milk, while relatively moderate homogenization may be required for the soybean soup or curd.

The average particle size may change from 30 to 150 μm depending on the degree and times of homogenizing pressure. When the soybean milk is subjected to three cycles of homogenization at 500 bar, the resulting whole soybean milk contains particles having an average particle diameter ranging from 60 to 90 μm and is suitable as a soybean milk product. For the soybean curd to be prepared through coagulation, it is sufficient to homogenize soybean milk once at 300 bar to obtain particles having an average particle diameter ranging from 100 to 120 μm.

Further, the whole soybean milk obtained by micronizing homogenization is preferably adjusted to a solid content ranging from 11 to 15 brix %, preferably, from 12 to 13 brix % so that it can be easily processed into various soybean food products. It is noted that, if the solid content becomes too high, the viscosity of the resulting soybean milk increases, which makes the processability of the soybean milk difficult, while a low solid content causes difficulties in the shape-forming step during the process of solid soybean food product such as soybean curd and snacks.

5) Degassing

The whole soybean milk produced by micronizing homogenization is degassed under a pressure ranging from 700˜760 mmHg for 15 to 50 minutes. The degassing procedure is advantageous in that disagreeable odor remaining in the soybean milk is removed together with minute air particles in the soybean milk. The degassed soybean milk has enhanced preservability, and the texture of solid soybean food product prepared therewith such as a bean curd is improved.

6) Preparation of Soybean Food Products

As further illustrated below, various types of soybean food products such as soybean milk, curd, etc., which comprises the entire nutritious components of whole soybeans, may be made by employing the whole soybean milk prepared above.

6-1) Whole Soybean Milk Products

The whole soybean milk prepared in 5) is processed into packaged soybean milk product through a conventional post-treatment process. The whole soybean milk may be added with a food additive, e.g., an additive for regulating the viscosity of the soybean milk, and a concentrated fruit extract or fruit juice for flavoring. When the soybean milk is packaged in a paper pack, the soybean milk is subjected to a sterilization at 150° C. for 3 seconds and then packaged so that the soybean milk product can be circulated at room temperature. In case of bottling, the soybean milk is filled in a bottle and then sterilized at 121° C. for 5 to 20 minutes. The whole soybean milk product contains soybean particles preferably having an average particle diameter of 50 μm or less, and has a viscosity ranging from 20 to 100 cps.

6-2) Whole Soybean Curd Products

0.3 to 0.9% by weight of a chemical coagulating agent is added to the whole soybean milk prepared in 5) to coagulate the soybean milk, and the coagulated soybean milk is compressed to yield a soybean curd product. 0.1 to 0.5% by weight of a protein cross-linking enzyme, e.g, transglutaminase, may be optionally added to the soybean milk. The elasticity and strength of the soybean curd may be enhanced when both of the chemical coagulating agent and the protein cross-linking enzyme are employed. Exemplary chemical coagulating agents include magnesium chloride, emulsified magnesium chloride, gluconodeltalactone (GDL), calcium sulfate, and a mixture thereof.

Further, it is preferable to coagulate the soybean milk at 50 to 85° C. for 40 to 110 minutes, and various types of whole soybean curd products such as uncurdled soybean curd, soft soybean curd and hard soybean curd may be made by regulating the degree of coagulation and compression.

A filling-type soybean curd is produced when the soybean milk is filled into a container and then coagulated, while a cutting-type soybean curd is obtained when soybean milk is coagulated and compressed, and the resulting bean curd is cut and packaged.

After packaging, the soybean curd is sterilized at a temperature ranging from 80 to 90° C. and then cooled to below 10° C. For the preparation of uncurdled soybean curd or soft soybean curd, it is preferable to first package the soybean milk and, then, carry out the coagulation and sterilization.

It is preferable to employ the soybean milk containing particles having an average particle diameter ranging from 40 to 90 μm in order to prepare a soybean curd product having a good texture.

6-3) Processed Soybean Milk Products

The whole soybean milk prepared in 5) is diluted, an appropriate amount of sitologically acceptable sweetener is added thereto, and the resulting soybean milk is packaged in the form of, e.g., a pouch, to produce an instant soybean soup. The soybean milk may contain particles having a relatively large average particle diameter, e.g., 90 to 120 μm.

Further, the whole soybean milk may be mixed with a fruit juice to produce a soybean milk-mixed beverage.

6-4) Processed Soybean Curd Products

The soybean curd prepared in 6-2) is mixed with wheat flour, egg and other materials, and the resulting dough is fried in oil to produce a soybean curd snack. The soybean curd may also be processed together with a boiled fish paste to obtain a boiled soybean-fish paste. The processed soybean curd products are preferably sterilized, packaged and frozen for circulation.

The following Examples are intended to further illustrate the present invention without limiting its scope.

### EXAMPLE 1

### Preparation of Whole Soybean Milk from Germinated Soybeans 1

### (Step 1) Preparation of Germinated Soybeans

300 kg of unpeeled soybean grains were selected, washed with water, and soaked in 1,200 l of 20° C. water for 10 hours.

The soak water was discharged, and the soaked soybeans were put in a germinating box at 20 to 30 mm thickness and then germinated at a temperature ranging from 20 to 25° C. for 0, 5, 10, 15 and 20 hours, respectively, while being covered with a lid to keep the surface of them moist. In order to promote germination, the soybeans were sufficiently watered at 2 to 3 hour intervals with water having a temperature ranging from 18 to 30° C.

Upon completion of the germination, the soybeans were washed with water and used in the subsequent process.

(Step 2) Preparation of Whole Soybean Milk from Germinated Soybeans

650 kg of the germinated soybeans obtained in step 1 were transferred to a crusher (Seiken, Japan) and subjected to milling with stirring, while adding thereto 1,500 l of distilled water. The resulting soybean slurry was heated at 105° C. for 3 minutes to inactivate the enzymes. 70 g of enzyme mixture (cellulase:pectinase=2:1)(cellulase: Amano, Japan; pectinase, Sungwoo Chem., Korea) was added to the slurry and the resulting mixture was subjected to continuous rotating micronization and enzyme degradation in a rotating micronizer (Hansung pulverulent machine, Korea) maintaining at 60° C.

The micronized soybean milk was homogenously micronized by employing a high-pressure homogenizer (Donga homogenizer, China) with applying a pressure of 300 bar to obtain whole germinated soybean milk (about 13 brix %) having an average particle size of 100 μm.

### EXAMPLE 2

### Preparation of Whole Soybean Milk from Germinated Soybeans 2

650 kg of the germinated soybeans obtained in step 1 were transferred to a crusher (Seiken, Japan) and subjected to milling with stirring, while adding thereto 1,500 l of distilled water. The resulting soybean slurry was heated at 105° C. for 3 minutes to inactivate the enzymes and passed through a decanter to separate solid materials and soybean milk. 50 g of enzyme mixture (cellulase:pectinase=2:1)(cellulase: Amano, Japan; pectinase, Sungwoo Chem., Korea) was added to the solid materials and the resulting mixture was subjected to continuous rotating micronization and enzyme degradation in a rotating micronizer (Hansung pulverulent machine, Korea) maintaining at 60° C.

The micronized soybean milk was homogenously micronized by employing a high-pressure homogenizer (Donga homogenizer, China) with applying a pressure of 500 bar, and combined with the soybean milk separated above to obtain whole germinated soybean milk (about 13 brix %) having an average particle size of 90 μm.

### EXAMPLE 3

### Preparation of Whole Soybean Milk from Soaked Soybeans 1

300 kg of unpeeled soybean grains were selected, washed with water, and soaked in 1,000 l of 15° C. water for 15 hours. The soak water was discharged and the soaked soybeans were transferred to a crusher (Seiken, Japan) and subjected to milling with stirring, while adding thereto 1500 l of distilled water. The resulting soybean slurry was heated at 105° C. for 3 minutes to inactivate the enzymes. 70 g of enzyme mixture (cellulase:pectinase=2:1)(cellulase: Amano, Japan; pectinase, Sungwoo Chem., Korea) was added to the slurry and the resulting mixture was subjected to continuous rotating micronization and enzyme degradation in a rotating micronizer (Hansung pulverulent machine, Korea) maintaining at 60° C.

The micronized soybean milk was homogenously micronized by employing a high-pressure homogenizer (Donga homogenizer, China) with applying a pressure of 300 bar to obtain whole soaked soybean milk having an average particle size of 100 μm.

### EXAMPLE 4

### Preparation of Whole Soybean Milk from Soaked Soybeans 2

300 kg of unpeeled soybean grains were selected, washed with water, and soaked in 1,000 l of 15° C. water for 15 hours. The soak water was discharged and the soaked soybeans were transferred to a crusher (Seiken, Japan) and subjected to milling with stirring, while adding thereto 1,500 l of distilled water. The resulting soybean slurry was heated at 105° C. for 3 minutes to inactivate the enzymes, and passed through a decanter to separate solid materials and soybean milk. 50 g of enzyme mixture (cellulase:pectinase=2:1)(cellulase: Amano, Japan; pectinase, Sungwoo Chem., Korea) was added to the solid materials and the resulting mixture was subjected to continuous rotating micronization and enzyme degradation in a rotating micronizer (Hansung pulverulent machine, Korea) maintaining at 60° C.

The micronized soybean milk was homogenously micronized by employing a high-pressure homogenizer (Donga homogenizer, China) with applying a pressure of 500 bar, and combined with the soybean milk separated above to obtain whole soaked soybean milk having an average particle size of 90 μm.

### EXAMPLE 5

### Preparation of Whole Soybean Milk without Powdering Process

1 kg of unpeeled soybean grains were selected, washed with water, and soaked in 3 l of 10° C. distilled water for 20 hours. The soak water was discharged and the soaked soybeans were transferred to a crusher (Seiken, Japan) and subjected to milling with stirring, while adding thereto 5 l of distilled water. The resulting soybean slurry was heated at 100° C. for 2 minutes to inactivate the enzymes, and homogenously micronized by employing a high-pressure homogenizer (Donga homogenizer, China) with applying a pressure of 500 bar to obtain whole soybean milk having an average particle size of 110 μm and a solid content of 13 brix %.

### EXAMPLE 6

### Preparation of Hard Soybean Curd 1

10 kg of the whole germinated soybean milk prepared in Example 1 was cooled to 5° C., and 30 g of transglutaminase (Amano, Japan) as a protein cross-linking enzyme, 27.5 g of magnesium chloride as a chemical coagulating agent and 5 g of salt were added thereto. The mixture was coagulated at 60° C. for 1 hour and the resulting coagulated curd was cut, packaged, sterilized and cooled to obtain cut soybean curd.

### EXAMPLE 7

### Preparation of Hard Soybean Curd 2

520 kg of the whole soaked soybean milk prepared in Example 3 was cooled to 5° C., and 1.6 kg of transglutaminase (Amano, Japan) as a protein cross-linking enzyme, 1.5 kg of magnesium chloride as a chemical coagulating agent and 500 g of salt were added thereto. The mixture was coagulated at 60° C. for 1 hour and the resulting coagulated curd was cut, packaged, sterilized and cooled to obtain cut soybean curd.

### EXAMPLE 8

### Preparation of Hard Soybean Curd 3

5 kg of the whole soybean milk prepared in Example 5 was cooled to 5° C. and filled in a coagulation tank, and 15 g of transglutaminase as a protein cross-linking enzyme, 15 g of magnesium chloride as a chemical coagulating agent and 5 g of salt were added thereto. The mixture was coagulated at 60° C. for 1 hour and the resulting coagulated curd was cut, packaged, sterilized and cooled to obtain hard soybean curd.

### EXAMPLE 9

### Preparation of Hard Soybean Curd 4

A hard soybean curd was prepared in accordance with the same method as in Example 8 except that the coagulated curd was additionally coagulated at 85° C. for 30 minutes.

### EXAMPLE 10

### Preparation of Hard Soybean Curd 5

A hard soybean curd was prepared in accordance with the same method as in Example 8 except that 10 g of magnesium chloride and 5 g of gluconodeltalactone were used as chemical coagulating agents.

### EXAMPLE 11

### Preparation of Hard Soybean Curd 6

A hard soybean curd was prepared in accordance with the same method as in Example 8 except that 10 g of magnesium chloride and 5 g of gluconodeltalactone were used as chemical coagulating agents and the coagulated curd was additionally coagulated at 85° C. for 30 minutes.

### EXAMPLE 12

### Preparation of Filled Soybean Curd 1

10 kg of the whole germinated soybean milk prepared in Example 1 was cooled to 5° C., and 30 g of transglutaminase (Amano, Japan) as a protein cross-linking enzyme and 20 g of magnesium chloride and 10 g of gluconodeltalactone as chemical coagulating agents were added thereto. The mixture was filled into a container, which is then sealed tightly. The mixture was subjected to coagulation at 60° C. for 1 hour and additional coagulation at 85° C. for 30 minutes to obtain filled soybean curd.

### EXAMPLE 13

### Preparation of Filled Soybean Curd 2

520 kg of the whole soaked soybean milk prepared in Example 3 was cooled to 5° C., and 1.6 kg of transglutaminase as a protein cross-linking enzyme and 1 kg of magnesium chloride and 500 g of gluconodeltalactone as chemical coagulating agents were added thereto. The mixture was filled into a container, which is then sealed tightly. The mixture was subjected to coagulation at 60° C. for 1 hour and additional coagulation at 85° C. for 30 minutes to obtain filled soybean curd.

### COMPARATIVE EXAMPLE 1

### Preparation of Soybean Curd Using Germinated Soybeans Having Different Germinating Periods

Unpeeled soybean grains were soaked in water and germinated for 4 and 5 days, respectively, as in Step 1 of Example 1. Whole soybean milk was prepared from these germinated soybeans in accordance with the method of Step 2 of Example 1, and hard soybean curds were prepared therefrom in accordance with the method of Example 6.

### COMPARATIVE EXAMPLE 2

### Preparation of Soybean Milk Using Peeled Soybeans

Soybean milk was prepared by employing 300 kg of peeled soybeans in accordance with the method of Example 3.

### COMPARATIVE EXAMPLE 3

### Preparation of Soybean Curd Using a Raw Soybean Powder

A raw soybean powder of 350 mesh particle size was mixed with water at a weight ratio of 1:6, and the mixture was steamed and cooled to obtain soybean milk of 13 brix %. A hard soybean curd was prepared in accordance with the method of Example 8, except that the soybean milk prepared above was used as a whole soybean milk and the coagulated curd was additionally coagulated at 85° C. for 30 minutes.

### TEST EXAMPLE 1

### Analysis of Nutritious Components

The nutritious components of the soybean milks prepared in Example 3 and Comparative Example 2 were analyzed. Specifically, the contents of protein, raw fat and raw fibrous material were analyzed by micro Kjeldahl method, ether extraction method and AOAC method, respectively. The result is shown in Table 1 as percentages based on dried weight.

TABLE 1

| | | Example 3 | Comparative Example 2 |
|---|---|---|---|
| Nutritious | Protein | 38.0 | 40.2 |
| components | Raw fat | 18.0 | 19.5 |
| | Raw fiber | 8.5 | 6.7 |

As can be seen from Table 1, the content of raw fibrous materials in the soybean milk prepared in Example 3 is higher by 27% than that prepared in Comparative Example 2. This result demonstrates that the dietary fibers rich in soybean peels are contained in the inventive soybean milk.

### TEST EXAMPLE 2

### Sensory Evaluation 1

The soybean curds prepared in Example 6 and Comparative Example 1 were provided to 10 professional panels and the elasticity, strength and taste of the soybean curds were evaluated by 5-point scoring test, respectively. The result is shown in Table 2.

TABLE 2

| | | Example 6 | | | | | Comp. Exam. 1 | |
|---|---|---|---|---|---|---|---|---|
| Germinated | Germination | 1 | 1.5 | 2 | 2.5 | 3 | 4 | 5 |
| soybeans | period (days) | | | | | | | |
| | Length of Bud | 0 | 3 | 7 | 15 | 30 | 50 | 150 |
| | (hypocotyls) | | | | | | | |
| | (mm) | | | | | | | |

| | | | | | | | |
|---|---|---|---|---|---|---|---|
| Result | 3/3/4 | 5/5/4 | 5/5/5 | 4/4/4 | 3/4/4 | 2/3/3 | 1/3/1 |
| (elasticity/strength/taste) | | | | | | | |

According to the result shown in Table 1, the soybean curds prepared by employing the soybeans germinated for 1.5 to 3 days exhibited good points in the elasticity, strength and taste items. Especially, the soybean curds prepared by employing the soybeans germinated for 2 days exhibited best result.

Further, the soybean curds prepared by employing the soybeans germinated for more than 3 days exhibited low strength and poor taste because the germinated soybeans has too long bud and their protein contents were reduced.

### TEST EXAMPLE 3

### Sensory Evaluation 2

The soybean curds prepared in Example 7 and a soybean curd prepared by employing the soybean milk of Comparative Example 2 in accordance with the method of Example 7 were provided to 10 professional panels and the elasticity, strength, flavor and taste of the soybean curds were evaluated by 5-point scoring test, respectively. The result is shown in Table 3.

TABLE 3

| | | | Soybean curd prepared |
|---|---|---|---|
| | | Soybean curd | from Comparative |
| | | of Example 7 | Example 2 |
| Sensory | Elasticity | 3.8 | 4.1 |
| evaluation | Strength | 4.0 | 4.4 |
| | Flavor | 4.4 | 4.2 |
| | Taste | 4.6 | 4.7 |

As can be seen from Table 3, soybean curd of Example 7 prepared by employing whole soybean milk showed lower elasticity and strength than the soybean curd prepared by the method of Example 7 by employing the soybean milk of Comparative Example 2 (comparative soybean curd), while it showed the substantially same taste as the comparative soybean curd. Moreover, it has stronger flavor than the comparative soybean curd because it contains soybean peel components.

### TEST EXAMPLE 4

### Sensory Evaluation 3

The soybean curds prepared in Examples 8 to 11 and Comparative Example 3 were provided to 10 professional panels and the elasticity, strength, flavor and taste of the soybean curds were evaluated by 5-point scoring test, respectively. The result is shown in Table 4.

TABLE 4

| | Points for Elasticity/Strength/Flavor/Taste |
|---|---|
| Example 8 | 5/4/5/5 |
| Example 9 | 5/5/5/5 |
| Example 10 | 5/4/5/5 |
| Example 11 | 5/5/5/5 |
| Comparative Example 3 | 4/4/2/3 |

As can be seen from Table 4, the whole soybean curds prepared in Examples 8 to 11 without adopting soybean powdering process exhibited good evaluation results in terms of Elasticity/Strength/Flavor/Taste. In contrast, the soybean curd prepared in accordance with Example 3 by employing the raw soybean powder gained low points in terms of elasticity and strength, and much lower points especially in terms of flavor and taste. It seems that this soybean curd has off-flavor due to the oxidation of the raw soybean powder and bad feelings in the mouth due to the rough texture of the soybean curd having large particles of the soybean powder.

While the invention has been described with respect to the above specific embodiments, it should be recognized that various modifications and changes may be made to the invention by those skilled in the art which also fall within the scope of the invention as defined by the appended claims.

1. A process for preparing a whole soybean milk comprising the steps of mechanically milling soaked or germinated soybeans; micronizing the resulting crude-milled soybeans by a means selected from the group consisting of an enzymatic means, mechanical means and a combination thereof; and homogenizing the resulting soybean milk, wherein no soybean refuse is generated.

2. A process for preparing a whole soybean milk comprising the steps of mechanically milling soaked or germinated soybeans; filtering the resulting crude-milled soybeans to obtain a solid portion and a first batch of soybean milk (first soybean milk), and micronizing the solid portion by a means selected from the group consisting of an enzymatic means, mechanical means and a combination thereof; and homogenizing the resulting micronized solid portion to obtain a second batch soybean milk (second soybean milk), and mixing the second soybean milk with the first soybean milk, wherein no soybean refuse is generated.

3. The process according to claim 1, wherein the length of bud (hypocotyl) of the germinated soybean is 30 mm or less.

4. The process according to claim 1, which further comprises an enzyme inactivation process by heating the crude-milled soybeans obtained after milling at a temperature ranging from 95 to 110° C. for 2 to 5 minutes.

5. The process according to claim 1, wherein a plant tissue degrading enzyme is employed in the micronization step.

6. The process according to claim 5, wherein the plant tissue degrading enzyme is selected from the group consisting of cellulase, hemicellulase, pectinase and a mixture thereof.

7. The process according to claim 1, wherein the homogenization step is conducted by a method selected from the group consisting of high-pressure homogenization, sonication, electrolysis, air pressure spray and a combination thereof.

8. The process according to claim 1, wherein the homogenization step is conducted by a high-pressure homogenization step employing a pressure ranging from 150 to 700 bar.

9. The process according to claim 1, wherein the soybean milk obtained after the homogenization have a average particle size ranging from 30 to 150 μm.

10. The process according to claim 1, wherein the soybean milk obtained after the homogenization have a solid material content ranging from 11 to 15 brix %.

11. The process according to claim 1, which does not require the step of powdering the dried soybeans.

12. A soybean food product prepared by adding a sitologically acceptable additive to the whole soybean milk.

13. The soybean food product according to claim 1, which is soybean milk or instant soybean soup.

14. A process for preparing a whole soybean curd comprising adding a coagulating agent to the whole soybean milk prepared by the process according to claim 1.

15. The process according to claim 14, wherein the coagulating agent is a chemical coagulating agent selected from the group consisting of magnesium chloride, emulsified magnesium chloride, gluconodeltalactone (GDL), calcium sulfate and a mixture thereof, or a protein cross-linking enzyme.

16. A soybean curd prepared by the process of claim 14.

17. A food product prepared by processing the soybean curd of claim 16.

18. The food product of claim 17, which is a snack, donut, soybean curd patty, soybean curd ice cream or boiled soybean curd-fish paste.

19. The process according to claim 2, wherein the length of bud (hypocotyl) of the germinated soybean is 30 mm or less.

20. The process according to claim 2, which further comprises an enzyme inactivation process by heating the crude-milled soybeans obtained after milling at a temperature ranging from 95 to 110° C. for 2 to 5 minutes.

21. The process according to claim 2, wherein a plant tissue degrading enzyme is employed in the micronization step.

22. The process according to claim 21, wherein the plant tissue degrading enzyme is selected from the group consisting of cellulase, hemicellulase, pectinase and a mixture thereof.

23. The process according to claim 2, wherein the homogenization step is conducted by a method selected from the group consisting of high-pressure homogenization, sonication, electrolysis, air pressure spray and a combination thereof.

24. The process according to claim 2, wherein the homogenization step is conducted by a high-pressure homogenization step employing a pressure ranging from 150 to 700 bar.

25. The process according to claim 2, wherein the soybean milk obtained after the homogenization have a average particle size ranging from 30 to 150 μm.

26. The process according to claim 2, wherein the soybean milk obtained after the homogenization have a solid material content ranging from 11 to 15 brix %.

27. The process according to claim 2, which does not require the step of powdering the dried soybeans.

28. A process for preparing a whole soybean curd comprising adding a coagulating agent to the whole soybean milk prepared by the process according to claim 2.

29. The process according to claim 28, wherein the coagulating agent is a chemical coagulating agent selected from the group consisting of magnesium chloride, emulsified magnesium chloride, gluconodeltalactone (GDL), calcium sulfate and a mixture thereof, or a protein cross-linking enzyme.

30. A soybean curd prepared by the process of claim 28.

31. A food product prepared by processing the soybean curd of claim 30.

32. The food product of claim 31, which is a snack, donut, soybean curd patty, soybean curd ice cream or boiled soybean curd-fish paste.
